(19) United States
(12) Patent Application Publication
(10) Pub. No.: US 2002/0123942 A1
(43) Pub. Date: Sep. 5, 2002

(54) Preview system for floor covering installations

(76) Inventors: James C. Bridges JR., LaGrange, GA (US); Charles P. Hoffner JR., LaGrange, GA (US)

Correspondence Address: Terry T. Moyer, P.O. Box 1927, Spartanburg, SC, 29304, US

(21) Appl. No.: 09/797,067

(22) Filed: Mar. 1, 2001

(51) Int. Cl. G06F 17/60

(52) U.S. Cl. 705/27

(57) ABSTRACT

A system whereby a prospective purchaser of floor coverings may be provided with a simulated view of various floor covering styles and patterns within the actual contemplated environment of use including furniture, walls, and other non-floor covering elements within the environment of use. A view of the proposed environment of installation is communicated to a floor covering manufacturer or other designated entity for manipulation of the image in digital form to display floor covering products of interest to the purchaser within the proposed environment of use. The generated images are thereafter communicated back to the potential purchaser for his or her review and consideration. A standardized product identification system is utilized to insure that the floor coverings of interest to the potential consumer are imported into the digitized view.

### TECHNICAL FIELD

The present invention relates to a system and method for evaluation of patterns for carpet and other floor coverings. More particularly, the present invention is directed to a system for evaluating the post installation appearance of a group of different carpet styles and colors in a predetermined environment of use prior to actual purchase and installation of the carpeting.

### BACKGROUND OF THE INVENTION

Conventional evaluation of floor covering or flooring products such as carpeting carpet tiles and area rugs involves the customer viewing the floor covering in a retail purchase environment and attempting to make a mental impression of how such floor covering will ultimately appear in an installed state within the final area of use. The process is further complicated by the fact that carpeting and carpet tiles are generally viewed by the customer in the form of relatively small samples which may make it difficult to envision the final floor covering in its installed state. Area rugs are generally viewed as completed units, but the actual appearance of such products may nonetheless be difficult to envision in the ultimate environment of use due to the fact that other elements such as furniture coloration, wall coloration, wall treatments, lamps, lighting, and other environmental factors will necessarily have an impact on the ultimate appearance of such products. Thus, a product which appears to be desirable to the customer in a showroom environment may ultimately prove to be aesthetically disappointing once installed.

The fear of such disappointment following installation leaves many consumers to select floor covering in neutral tones to avoid confusion. The consumer is thus foreclosed from taking advantage of more complex and potentially aesthetically desirable multi-colored or patterned floor coverings or floor coverings with designs without risking disappointment. Moreover, in the event that the consumer elects to select a color or pattern which has not been previously used in the area to be covered and the customer is thereafter disappointed with the results, the relationship between the customer and the supplier of the floor covering may be harmed thereby reducing the likelihood of subsequent business transactions.

Hence, there is a need for an improved process, method and/or product for viewing selected floor covering, especially multi-colored, patterned floor coverings.

### SUMMARY OF THE INVENTION

The present invention provides advantages and alternatives over the prior art by providing a system, method and product whereby a prospective purchaser of floor coverings may be provided with a simulated view of various floor covering styles, designs, colors, and patterns within the actual contemplated environment of use including furniture, walls, and other non-floor covering elements within the environment of use. This system thus affords the potential purchaser an opportunity to compare and contrast the likely appearance of various carpet styles, designs, patterns, and color schemes within the actual environment in which the product will be used. This invention preferably provides a system whereby a digitized view of the proposed environment of installation is communicated to a floor covering manufacturer or other designated entity for manipulation of the digitized image to display floor covering products of interest to the purchaser within the proposed environment of use. The generated images are thereafter communicated back to the potential purchaser for his or her review, consideration, and selection of a product or products. In one preferred embodiment, a standardized product identification system is utilized to insure that the floor coverings of interest to the potential consumer are imported into the digitized view. Thus, the potential purchaser will select one or more carpet styles, designs, colors and patterns from a pre-established database which corresponds to the database of styles and coloration patterns available to the point of sale or entity providing the view manipulation.

These advantages are accomplished in a potential preferred form of the invention by providing a system whereby a potential purchaser transmits via the Internet a digital image of the area to be covered by the floor covering and a listing of styles and colors identified by a recognized product code to a pre-established electronic address. Upon receipt of such information the entity designated to carry out the view manipulation initiates digital image manipulation software so as to replace the original view of the flooring surface with a view illustrating coverage by the pre-identified floor covering elements of interest to the potential purchaser. The resultant preview image or images are preferably tagged with a product identifier corresponding to the floor covering product illustrated and are thereafter communicated back to the potential purchaser via the Internet for review, consideration, and selection. Preferably, the supplier of the service is either the manufacturer of the floor covering product of interest or a designated representative of the manufacturer having access to the catalog of floor covering styles and colorations currently available from the manufacturer (sales person, dealer, distributor, etc.).

In accordance with yet another potentially preferred aspect of the present invention, the generation of the initial digital image of the proposed environment of use may be carried out by a representative of the retail entity working with the potential customer for submission to the retail entity for digital manipulation. The potential purchaser is thereby relieved of any responsibility for communicating with the entity conducting the manipulation.

It is a feature of the present invention that the potential purchaser may also submit images of the area to be covered by the floor covering in non-digital form. Such images may be scanned or otherwise placed into a digital form which may thereafter be manipulated for importation of styles, designs, and colors of interest to generate simulated preview images. These preview images may thereafter be submitted back to the potential customer by electronic or non-electronic delivery means for his or her review and consideration.

In one implementation of the present invention, the identification codes for styles and colors of floor coverings of interest may be retrieved from the Web site of the carpet manufacturer or supplier and may thereafter be submitted by the potential customer along with the digital image of the surface to be covered. The resulting manipulated images may thereafter be sent back to the requester at his or her return address or may be retrieved by the requester at some subsequent time through the Web site.

### BRIEF DESCRIPTION OF THE DRAWINGS

These and other features and advantages of the present invention will now be described in further detail with reference to the drawings of certain preferred embodiments which constitute a part of this specification and in which:

FIG. 1 is a flow chart setting forth steps according to one embodiment of the present invention.

FIGS. 2A-2C are flow charts detailing potentially preferred steps carried out in association with each block step set forth in FIG. 1;

FIG. 3 is a representation of a screen display illustrating a digital image of a room including floor covering elements and non-floor covering elements;

FIG. 4 is a representation of a screen display wherein non-floor covering elements have been removed to define a visible surface for floor covering image manipulation;

FIG. 5 is a view similar to FIG. 3 wherein a new floor covering pattern has been inserted across the visible floor covering surface and previously removed non-floor covering elements have been reinserted;

FIG. 6 is a representation of a screen display wherein all elements have been removed with the exception of shadows;

FIG. 7 is a representation of a screen display similar to FIG. 5 wherein a new floor covering pattern and shadows have been inserted across the visible floor covering surface;

FIG. 8 is an example of a story board showing an exemplary example of the present invention with three different patterns displayed; and

FIGS. 9-14 are black and white copies of color FIGS. 3-8.

While the invention has been illustrated and generally described above and will hereinafter be described in connection with certain exemplary or potentially preferred embodiments, practices, and procedures, it is to be understood that in no event is the invention to be limited to such illustrated embodiments, practices, and procedures which are provided for illustrative purposes only. On the contrary, it is intended that the present invention shall extend to all alternatives and modifications as may embrace the principles of this invention within the true spirit and scope thereof.

### DETAILED DESCRIPTION OF THE INVENTION

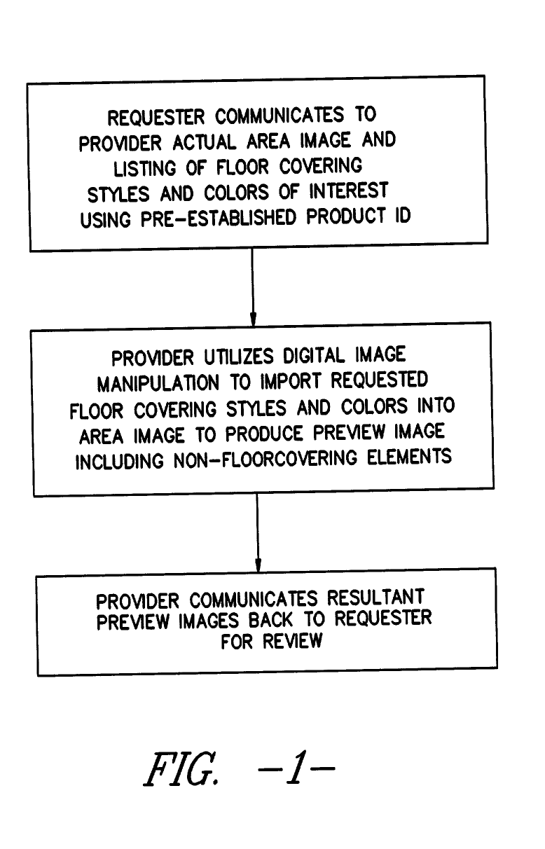

FIG. 1 illustrates the general architecture of a floor covering preview system in accordance with an exemplary embodiment of the present invention. In the potentially preferred embodiment, the system incorporates process steps which may be categorized within basic activity blocks as set forth in FIG. 1. As illustrated, it is contemplated that in the potentially preferred form of the present invention the initial activity block entails the communication of an area image where the floor covering is to be installed along with a listing of floor covering styles and colors of interest from the customer or a representative of the customer (hereinafter referred to as the “Requester”) to an entity such as the floor covering manufacturer or an authorized representative of the manufacturer (hereinafter referred to as the “Provider”).

It is to be appreciated that the present invention contemplates that the Requester making the communication may be either the ultimate user of the floor covering or may be an intermediate facilitating agent such as a retail merchant of the floor covering material, an architectural firm, or a professional decorator. The Provider to whom the image and listing of floor coverings is submitted may likewise be either a manufacturer of such floor covering products or a qualified entity having access to a catalog of styles and colors of floor coverings produced by the manufacturer in an accessible electronic format.

The present invention is especially well suited to provide a potential or prospective customer with a visualization of patterned and/or multi-color carpet (broad loom, area rugs, carpet tiles, floor mats, etc.) or carpet having designs thereon. Such patterned carpet is made by either weaving or tufting with colored yarns, inlaying colored patches, or printing (or dyeing) the pattern or designs on white, off white, beige, or colored tufted, bonded, woven, or non-woven substrates.

For example, textile materials are pattern colored with natural or synthetic dyes by processes, such as, transfer printing, jet dye injection, screen printing, hand painting, and the like.

In one embodiment, the patterns, colors or designs are printed or dyed on a blank carpet substrate or carpet tile, by a computer controlled jet dye machine, such as a MILLITRON® jet dye machine marketed by Milliken & Company, of Spartanburg, S.C. Such machines are described in U.S. Pat. No. 4,808,191 hereby incorporated by reference.

The dye gunbars of such jet dye machines (whether direct or indirect jet) are driven by digital firing commands which correspond to the digital pattern or image to be dyed or printed on the carpet substrate.

The floor covering digital pattern or design images are saved in one or more computer system databases and may be accessed to provide the pattern or design images for the present invention.

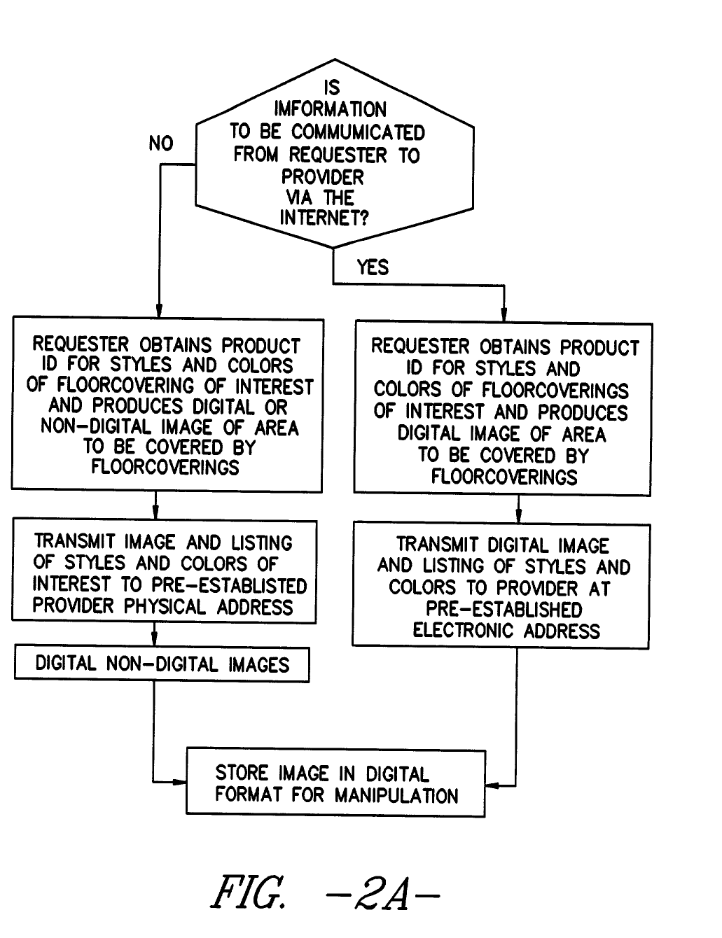

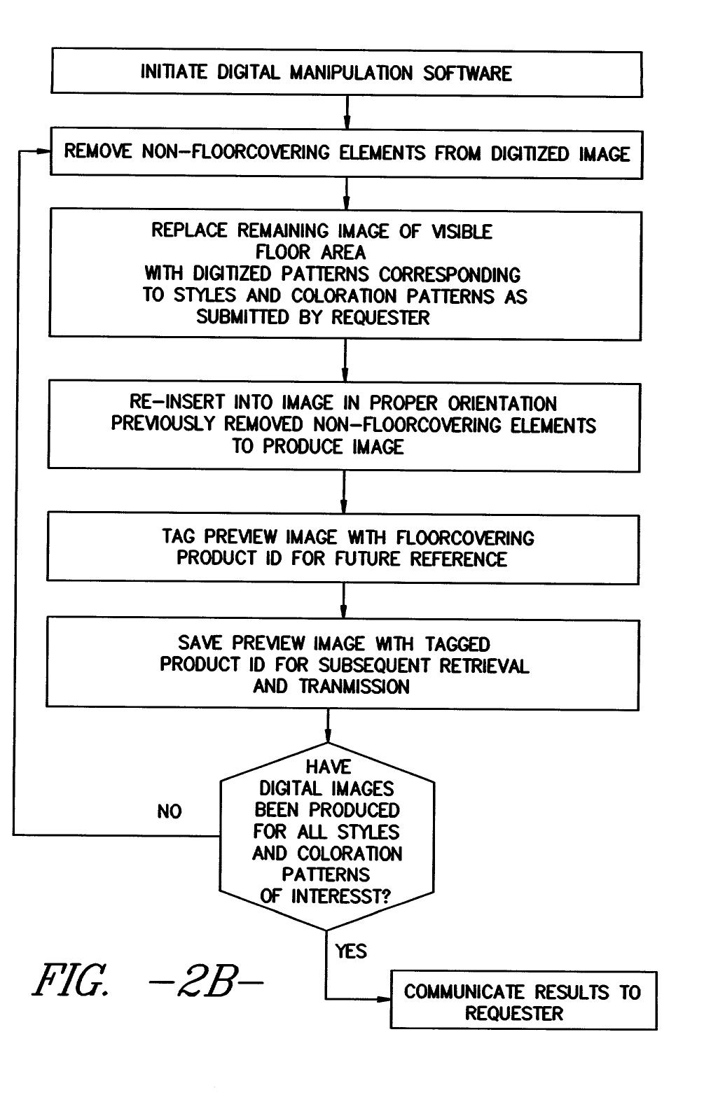

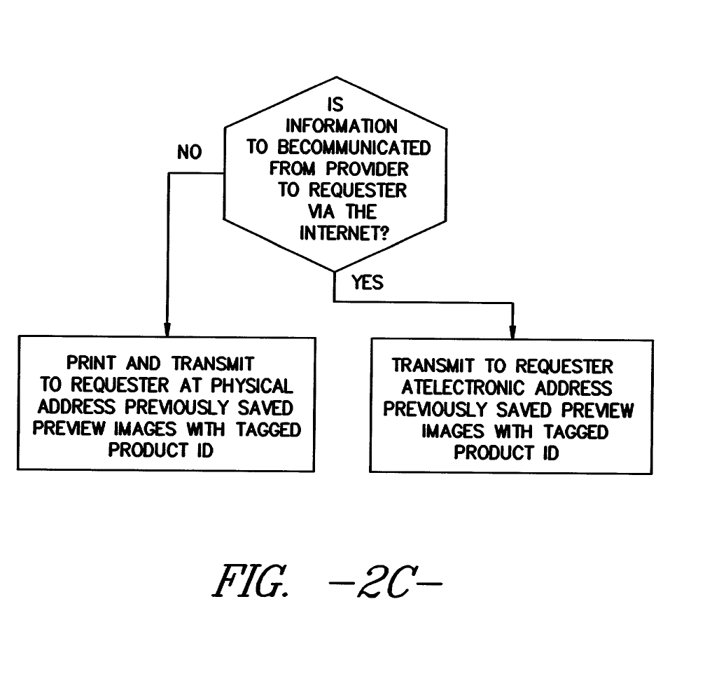

Turning to FIG. 2A, according to the potentially preferred practice of the present invention, the potential customer or other submitting entity first identifies one or more floor covering materials of potential interest. As will be appreciated, the identification of such materials may be carried out through reference to a physical or electronic database showing the various floor covering styles and coloration patterns available from the manufacturer of interest. Of course, the styles and coloration patterns of interest may also be identified through reference to a physical catalogue or personal examination at a sales location if desired.

According to the potentially preferred practice, the products of interest are identified through reference by the Requester to a Web Site maintained by the manufacturer of interest using a standard Web browser such as NETSCAPE NAVIGATOR or the like. In this regard, by the term Web Site is meant a computer system that serves informational content to a network using the standard protocols of the World Wide Web and is generally intended to encompass both (i) the hardware/software server components that serve the information content over the network, and (ii) the “backend” hardware/software components including any non-standard or specialized components, that interact with the server components to perform services for Web Site users. Such a Web Site will be preferably based upon HTML (HyperText Mark-up Language). As will be appreciated, HTML is a standard coding convention and set of codes for attaching presentation and linking attributes to informational content within documents. During a document authoring stage, the HTML codes are embedded within the information content of the document. When the Web document is subsequently transferred from a Web server to a browser, the codes are interpreted by the browser and used to parse and display the document. Additionally, in specifying how the Web browser is to display the document, HTML text can be used to create links to other Web documents. HTTP (HyperText Transport Protocol) is preferably used as the client-server protocol for the exchange of information (such as HTML documents), and requests for such documents between a browser and a Web server.

Upon contacting the manufacturer Web Site, the Requester may utilize his or her browser to review a large number of potential floor covering styles and patterns, each of which is preferably identified by a unique product ID. Of course, the same information may likewise be obtained through reference to traditional sample displays available through retail merchandising entities.

In accordance with the present invention, the Requestor will obtain an image of the area to be covered by the floor covering including any known furniture or other non-floor covering elements to be used in conjunction with the floor covering in the proposed installation. This image may be in the form either of a digital image or in the form of a traditional photograph, print, or other image which is scanned to produce a digital image.

Once the Requester has collected both a listing of floor covering products of interest and the image of the area where the floor covering is to be utilized, those elements are transmitted to the Provider for manipulation of the image to incorporate a view of the identified floor covering materials. According to the potentially preferred practice, both the image of the installation area as well as the listing of products of interest is communicated in electronic format. Such communication is preferably carried out via a link to the manufacturer Web Site at a location dedicated to such submissions. If desired, access to such a submission location may be password protected to insure that only pre-approved potential customers submitting legitimate inquiries have access. Thus, in one form of the invention, it is contemplated that submission of such information may be limited to approved distributors or design professionals.

Aside from submission through the manufacturer Web Site or by other electronic communication routes, it is likewise contemplated that the image and listing of floor covering products of interest may be communicated to the Provider in a physical format via an appropriate delivery mechanism.

Upon receipt of the image and listing of products, the Provider of image manipulation services will preferably digitize any image which is not already in digital form by means of color scanning or other appropriate techniques. Once the Provider of the image manipulation service has a digital image available, the Provider may thereafter initiate (either automatically or with human involvement), a digital image manipulation software application.

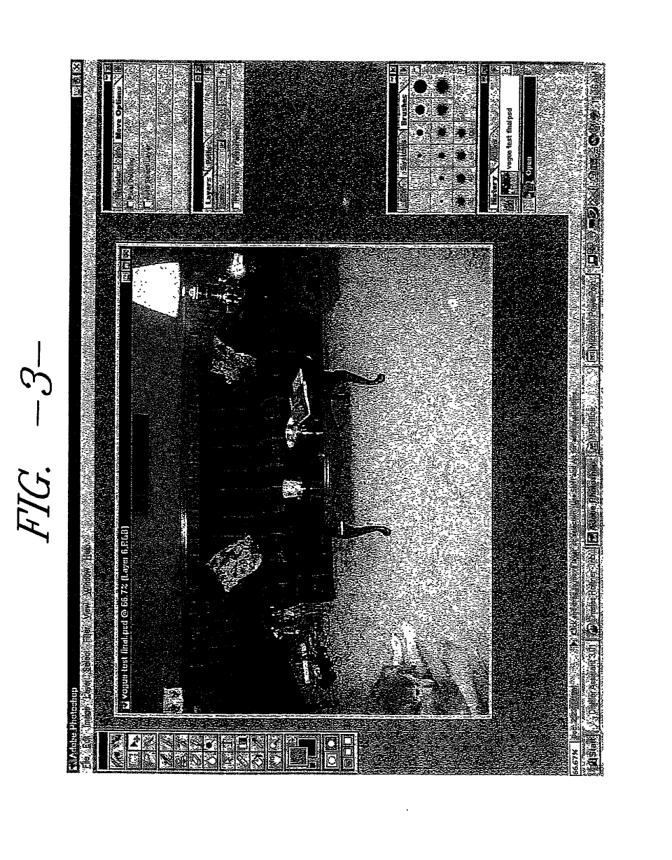

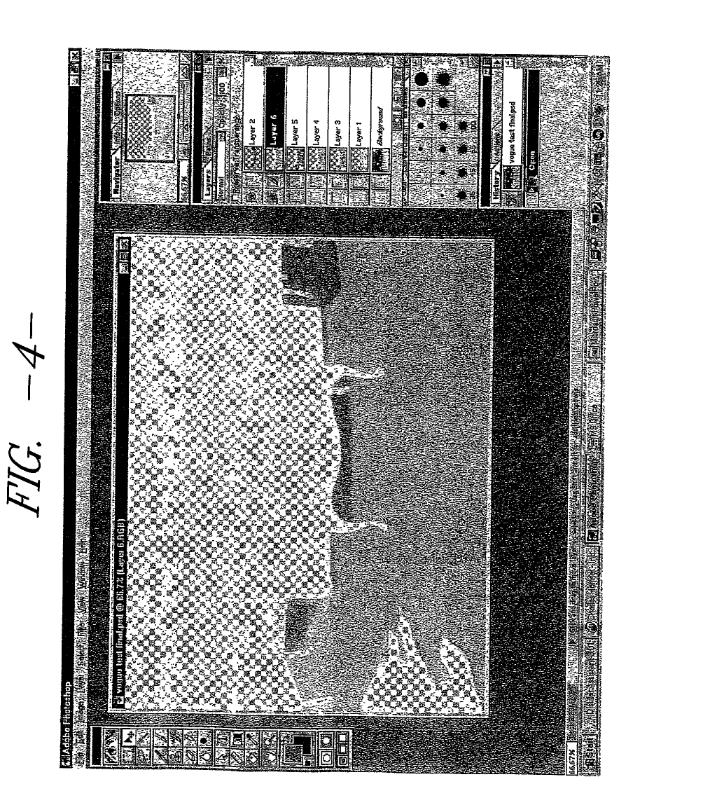

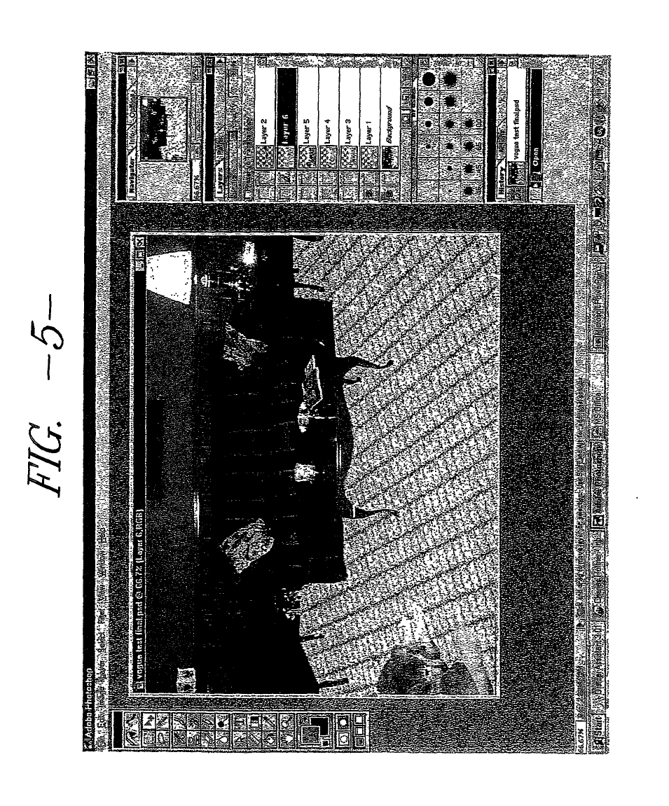

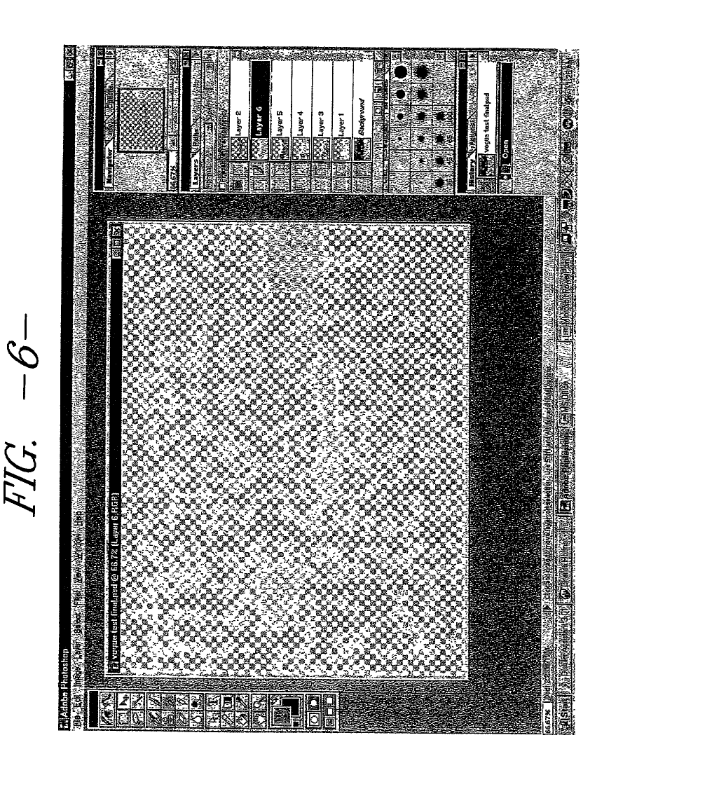

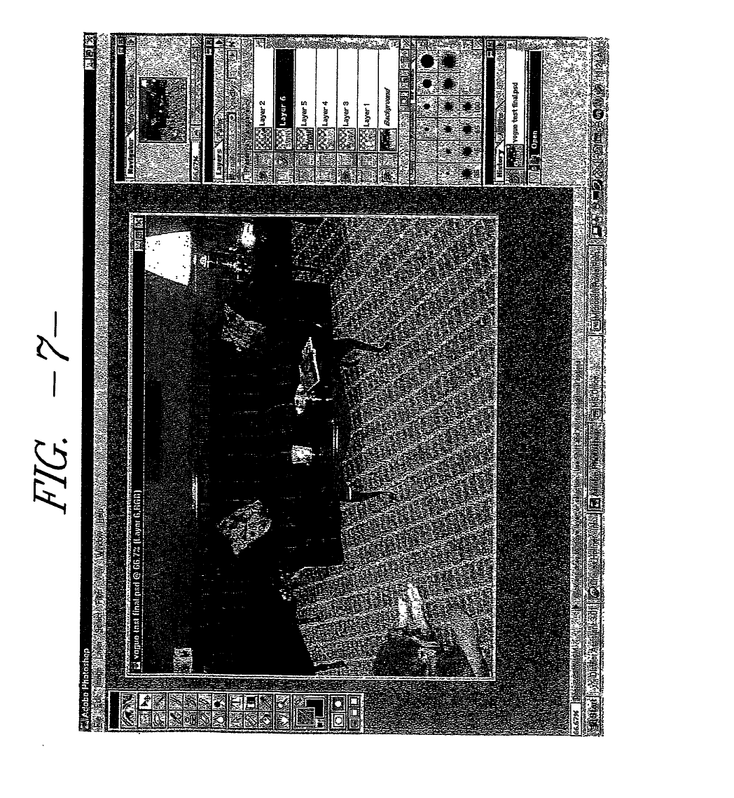

As best illustrated through simultaneous reference to FIGS. 2B, 3, 4, 5, 6, and 7, during the digital image manipulation, the non-floor covering elements are removed from the digital image of the area to be covered by the floor covering material. As best seen in FIG. 4, this removal results in the establishment of a plan view of the visible surface of the area covered by the floor covering. This plan view of the visible surface thus constitutes a manipulation surface of a defined geometry into which digitized patterns corresponding to the floor covering styles and colors of interest to the potential purchaser may be inserted. As shown, the manipulation surface may include sub-regions which are visible but covered by shadows cast by the removed non-floor covering elements. It is contemplated that such shadowed regions may be either maintained as distinguishable regions for shadowing treatment during subsequent manipulation of the image (as shown in FIGS. 6 and 7) or may be treated as non-discrete portions of the overall manipulation surface.

Once the surface subject to manipulation has been defined, the image manipulation software may be utilized to import images from a stored library of floor covering styles and coloration patterns so as to produce a digital reproduction of the floor covering of interest to the potential consumer. Shadowing features may be introduced over the previously identified sub-regions subject to shadows cast by the non-floor covering elements which have been previously removed. Once a digital reproduction of the floor covering of interest has been introduced into the view, the portion of the initial view which was previously removed may thereafter be reinserted in registry with the voids across the image resulting from such previous removal. The result is a reconstructed simulated preview image substantially identical to the initial image with the exception that the portion of the image corresponding to visible floor covering elements has been replaced with an image corresponding to a selected floor covering of differing style and/or coloration pattern. As will be appreciated, minor elements dispersed across the otherwise visible floor covering surface in the manipulation surface may be eliminated from the subsequent digitally produced preview image if desired so as to afford the prospective purchaser with a more comprehensive view of the likely appearance of the new floor covering within the proposed area of use.

Upon the generation of each manipulated image, that image, e-mail, or electronic message is preferably tagged in some manner with a product identifier corresponding to the illustrated floor covering so as to permit the perspective purchaser to correlate the image to a particular floor covering material during any subsequent purchase. Such tagging is believed to prevent subsequent confusion. The view manipulation may, of course, be repeated any number of times to produce multiple images each corresponding to a different floor covering material of interest.

As illustrated in FIG. 2C, once the manipulated preview images are produced, such images may be communicated back to the Requester for review and consideration. According to one potentially preferred practice, such communication will preferably be carried out via the Internet as an attachment to an E-mail message directed to the Requester's pre-established electronic address. It is also contemplated that the Requester may retrieve the images by linking to a pre-designated electronic retrieval address via the manufacturer Web Site. Image manipulation and communication will preferably utilize commonly available image manipulation and transmittal software such as Adobe PhotoShop or the like although any suitable image transmittal application may also be utilized. Of course, it is also contemplated that the preview images resulting from the view manipulation may be communicated in a physical format to the Requester at a pre-established physical address such as the store or their residence.

It is further contemplated that various other types of information can also be provided to the requester in the form of a feedback report provided with the preview images. For example, such feedback reports can provide additional information about various floor covering products and services such as product specifications, prices, ordering information, installation information, and options for cleaning and maintenance of such floor coverings after installation.

In accordance with one aspect of the present invention, there is provided computer simulated viewing of pattern carpet in a consumer's home through the use of digital images and MILLITRON® dye technology.

In accordance with another aspect of the present invention, there is provided a system, process, and product which allows the consumer to visualize MILLITRON® dyed pattern carpet in their home through images taken of their home. The process involves digital image manipulation of images of the consumer's home taken by, for example, the retail sales person. The image along with the style and colors of the pattern carpet are then e-mailed to, for example, the MILLIKEN® carpet and rug design studio in LaGrange, Ga. At the design studio, the design team can insert various pattern carpet selection into the consumer's actual room scene. Within forth-eight (48) hours of submitting to the MILLIKEN® design studio, the retailer will receive back via e-mail, the actual room image with various products shown. As soon as the consumer approves the pattern, he or she can place their order and have the carpet ready to be shipped to them within seven (7) working days.

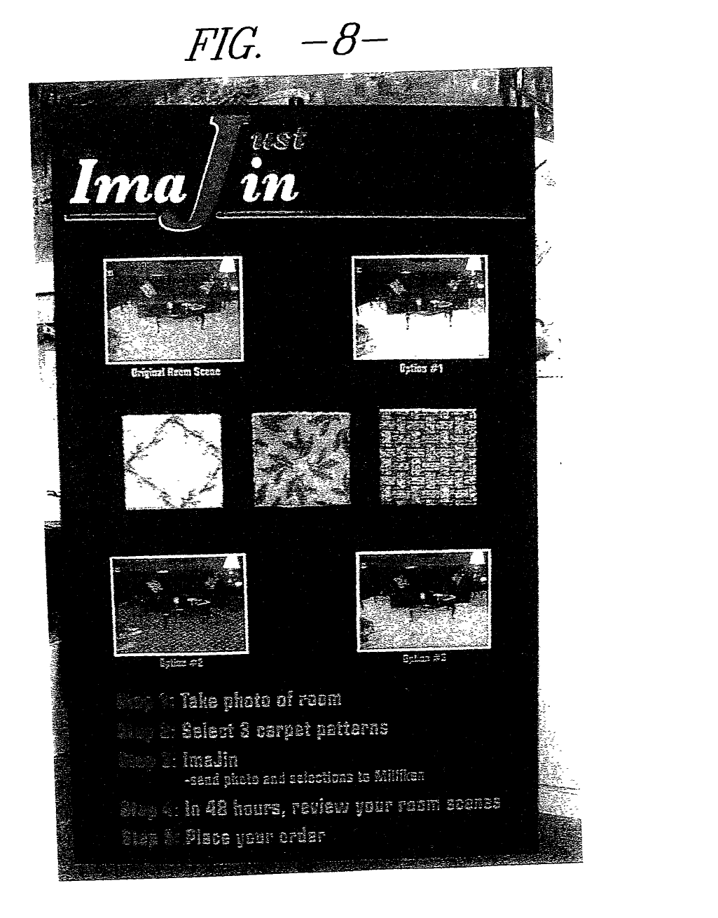

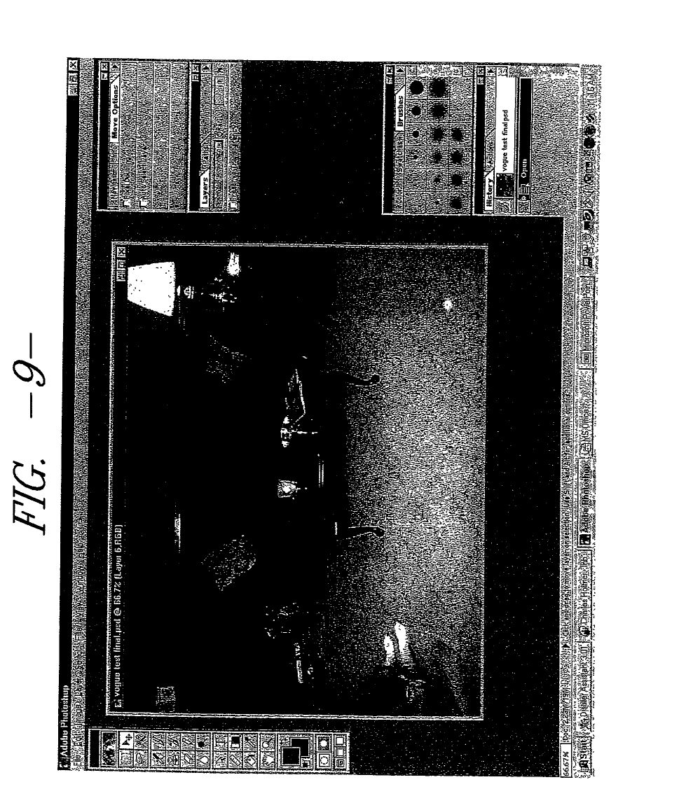

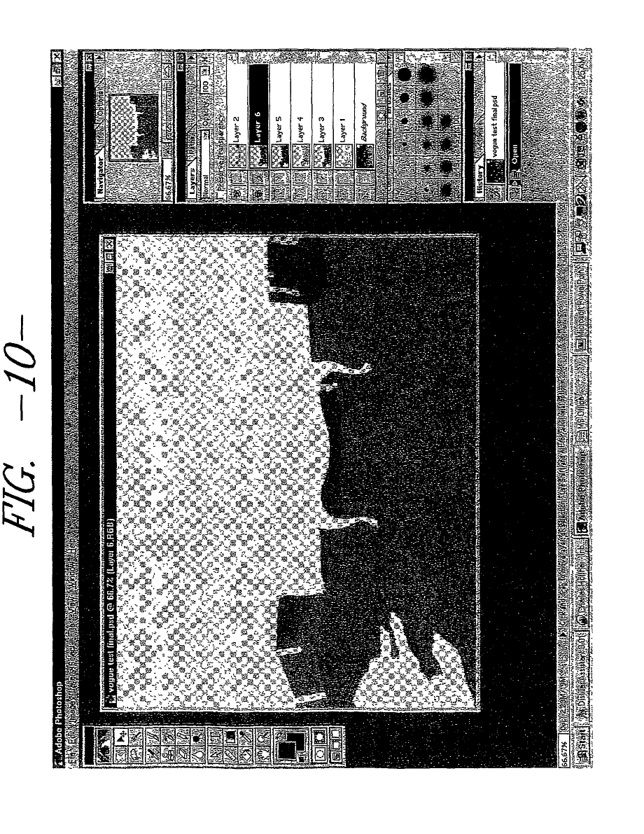

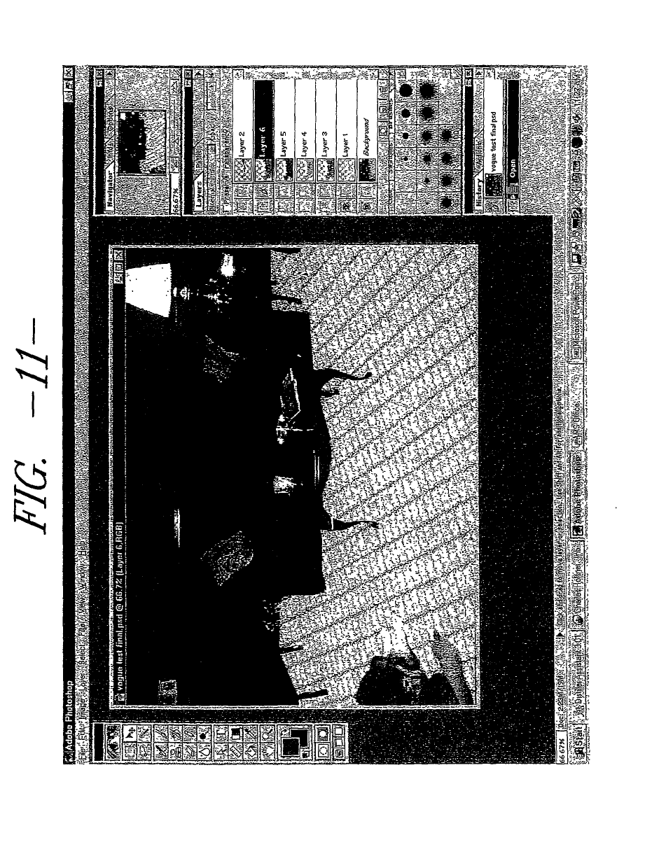

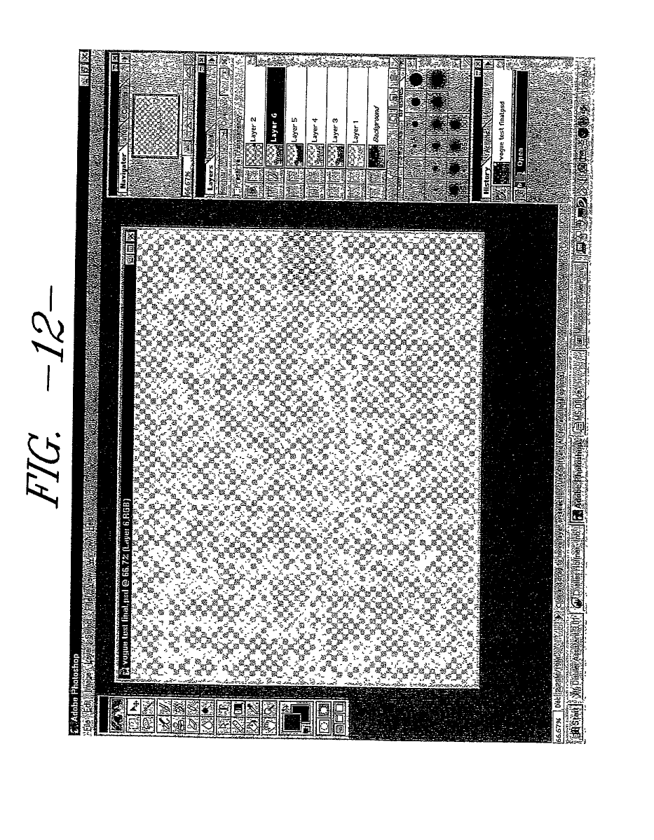

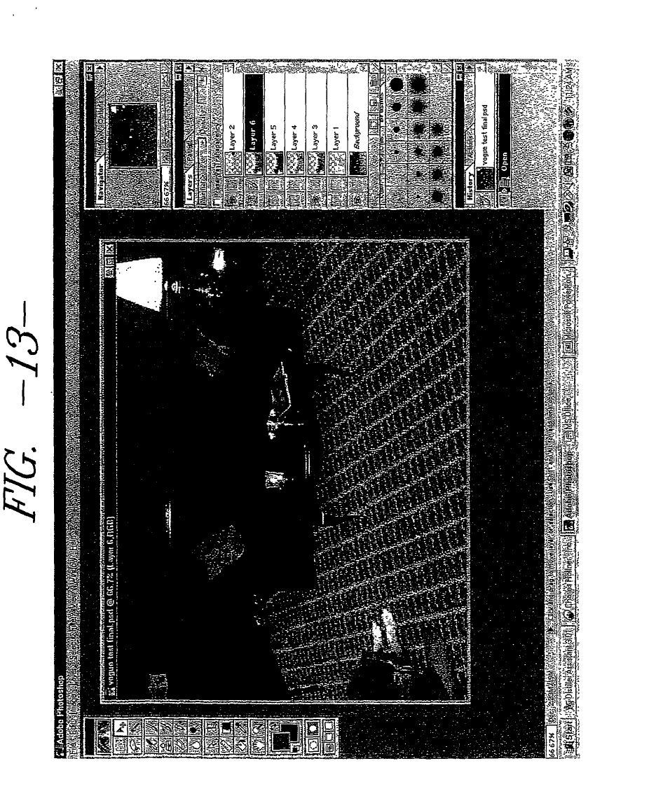

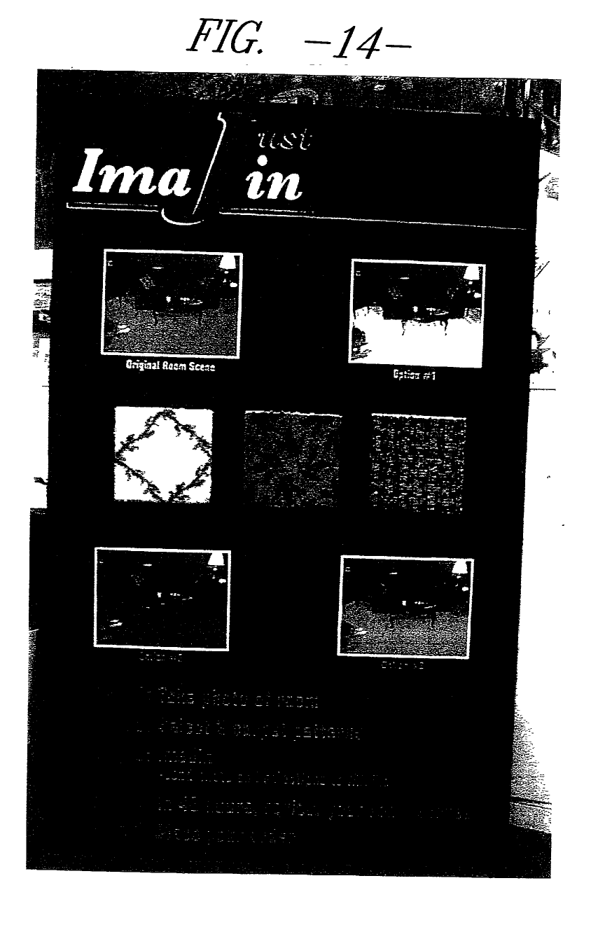

In accordance with the particular example of the present invention as shown in FIG. 8 of the drawings: Step 1, take a photo of the room; Step 2, select three (3) carpet patterns; Step 3, send the photo and selections to MILLIKEN®; Step 4, in forty-eight (48) hours, review your room scene; and Step 5, place your order. As shown in FIG. 8 of the drawings, the consumer is provided with three (3) different options or carpet pattern selections.

The present invention enhances the ability of the consumer to image, to imagine or visualize what the pattern carpet will look like in his or her own home. One advantage of the present invention is that pattern carpet now becomes as easy to select as solid or burger carpet.

As will be appreciated, while the invention has been illustrated and described herein with reference to certain embodiments, practices, and procedures, these embodiments, practices and procedures have been presented by way of example only and in no instance are to be construed as limiting the scope of the invention. Rather, it is contemplated that modifications and variations embodying the principles of this invention may likely occur to those of skill in the art and it is thus contemplated and intended that the present invention shall extend to all such modifications and variations as may incorporate the broad aspects of the invention within the true scope and spirit of the appended claims and all equivalents thereto.

What is claimed is:

1. A method of providing a prospective purchaser of floor covering products with simulated preview images of pre-selected floor covering products within a proposed area of installation, the method comprising the steps of:
obtaining a listing including at least one floor covering product of interest to the prospective purchaser wherein such floor covering product is designated in the listing by a pre-established product identifier recognizable to the manufacturer of the floor covering product;
obtaining a digital image of a proposed area of installation for the floor covering product wherein the digital image includes non-floor covering elements;
manipulating the digital image to remove non-floor covering elements such that a resulting manipulation surface corresponding substantially to the visible surface area to be covered by the floor covering within the proposed area of installation is obtained;
importing a digitized pattern simulating the floor covering product of interest into the digital image in registry over the manipulation surface;
reinserting at least a portion of the removed non-floor covering elements in a positional orientation corresponding substantially to the positional orientation prior to removal to yield a simulated preview image of the area to be covered which includes the floor covering product of interest; and
communicating the simulated preview image back to the prospective purchaser.

2. The method according to claim 1, wherein the listing includes a plurality of floor covering products of interest to the prospective purchaser and wherein each of said floor covering products is designated in the listing by a pre-established product identifier recognizable to the manufacturer of the floor covering product.

3. The method according to claim 1, wherein the digital image is obtained by means of electronic submission.

4. The method according to claim 3, wherein the electronic submission of the digital image is carried out by linking to an electronic delivery address through a Web Site established by the manufacturer of the floor covering product.

5. The method according to claim 3, wherein access to the electronic delivery address is limited to a group of pre-selected users.

6. The method according to claim 3, wherein communication of the simulated preview image back to the prospective purchaser is carried out electronically.

7. The method according to claim 6, wherein communication of the simulated preview image back to the prospective purchaser is carried out by accessing an electronic retrieval address through a Web Site established by the manufacturer of the floor covering product.

8. The method according to claim 6, wherein communication of the simulated preview image back to the prospective purchaser is carried out as an attachment to a return message directed to the electronic address from which the image was initially submitted.

9. The method according to claim 1, wherein the digital image is obtained by digitizing a standard photograph of the area of installation.

10. The method according to claim 1, wherein shading is applied at locations across the manipulation surface to simulate shadows cast by non-floor covering elements.

11. A simulated preview image produced by the method of claim 1.

12. A method of providing a prospective purchaser of floor covering products with simulated preview images of pre-selected floor covering products within a proposed area, of installation, the method comprising the steps of:
obtaining a listing including at least one floor covering product of interest to the prospective purchaser wherein such floor covering product is designated in the listing by a pre-established product identifier recognizable to the manufacturer of the floor covering product;
obtaining a digital image of a proposed area of installation for the floor covering product wherein the digital image includes non-floor covering elements;
manipulating the digital image to remove non-floor covering elements such that a resulting manipulation surface corresponding substantially to the visible surface area to be covered by the floor covering within the proposed area of installation is obtained;
importing a digitized pattern simulating the floor covering product of interest into the digital image in registry over the manipulation surface;
reinserting at least a portion of the removed non-floor covering elements in a positional orientation corresponding substantially to the positional orientation prior to removal to yield a simulated preview image of the area to be covered which includes the floor covering product of interest;
tagging the simulated preview image with a product identifier corresponding to the floor covering product illustrated in the simulated preview image; and
communicating the simulated preview image back to the prospective purchaser.

13. The method according to claim 12, wherein the listing includes a plurality of floor covering products of interest to the prospective purchaser and wherein each of said floor covering products is designated in the listing by a pre-established product identifier recognizable to the manufacturer of the floor covering product.

14. The method according to claim 12, wherein the digital image is obtained by means of electronic submission.

15. The method according to claim 14, wherein the electronic submission of the digital image is carried out by linking to an electronic delivery address through a Web Site established by the manufacturer of the floor covering product.

16. The method according to claim 14, wherein access to the electronic delivery address is limited to a group of pre-selected users.

17. The method according to claim 14, wherein communication of the simulated preview image back to the prospective purchaser is carried out electronically.

18. The method according to claim 17, wherein communication of the simulated preview image back to the prospective purchaser is carried out by accessing an electronic retrieval address through a Web Site established by the manufacturer of the floor covering product.

19. The method according to claim 17, wherein communication of the simulated preview image back to the prospective purchaser is carried out as an attachment to a return message directed to the electronic address from which the image was initially submitted.

20. The method according to claim 12, wherein the digital image is obtained by digitizing a standard photograph of the area of installation.

21. The method according to claim 12, wherein shading is applied at locations across the manipulation surface to simulate shadows cast by non-floor covering elements.

22. A simulated preview image produced by the method of claim 12.

23. A method of providing a requesting party with simulated preview images of pre-selected floor covering products within a proposed area of installation, the method comprising the steps of:
providing a Web site system linked to a browsable catalog of floor covering products and corresponding product identifiers for reference by the requesting party;
obtaining a listing from the requesting party of at least one floor covering product of interest wherein such floor covering product is designated in the listing by the product identifier corresponding to that product in the browsable catalog;
obtaining a digital image of a proposed area of installation for the listed floor covering product wherein the digital image includes non-floor covering elements;
manipulating the digital image to remove non-floor covering elements such that a resulting manipulation surface corresponding substantially to the visible surface area to be covered by the floor covering within the proposed area of installation is obtained;
importing a digitized pattern simulating the floor covering product of interest into the digital image in registry over the manipulation surface;
reinserting at least a portion of the removed non-floor covering elements in a positional orientation corresponding substantially to the positional orientation prior to removal to yield a simulated preview image of the area to be covered which includes the floor covering product of interest;
tagging the simulated preview image with a product identifier corresponding to the floor covering product illustrated in the simulated preview image; and
communicating the simulated preview image back to the requesting party.

24. The method according to claim 23, wherein the listing includes a plurality of floor covering products of interest to the requesting party and wherein each of said floor covering products is designated in the listing by the product identifier corresponding to that product in the browsable catalog.

25. The method according to claim 23, wherein the digital image is obtained by means of electronic submission.

26. The method according to claim 25, wherein the electronic submission of the digital image is carried out by linking to an electronic delivery address through the Web Site system.

27. The method according to claim 25, wherein access to the electronic delivery address is limited to a group of pre-selected users.

28. The method according to claim 25, wherein communication of the simulated preview image back to the requesting party is carried out electronically.

29. The method according to claim 28, wherein communication of the simulated preview image back to the requesting party is carried out by accessing an electronic retrieval address through the a Web Site service.

30. The method according to claim 28, wherein communication of the simulated preview image back to the requesting party is carried out as an attachment to a return message directed to the electronic address from which the image was initially submitted.

31. The method according to claim 23, wherein the digital image is obtained by digitizing a standard photograph of the area of installation.

32. The method according to claim 23, wherein shading is applied at locations across the manipulation surface to simulate shadows cast by non-floor covering elements.

33. A simulated preview image produced by the method of claim 23.

34. A method of providing a prospective purchaser of floor covering products with simulated preview images of floor covering products within a proposed area of installation, the method comprising the steps of:
manipulating a digital image of a proposed area of installation for the floor covering to remove the existing floor covering from the image such that a resulting manipulation surface corresponding substantially to the visible surface area to be covered by the new floor covering within the proposed area of installation is obtained; and
importing a digitized pattern simulating the new floor covering product of interest into the digital image in registry over the manipulation surface to yield a simulated preview image of the area to be covered which includes the new floor covering product of interest.

35. The method according to claim 34, further comprising the step of obtaining a listing of a plurality of floor covering products of interest to the prospective purchaser and wherein each of said floor covering products is designated in the listing by a pre-established product identifier recognizable to the manufacturer of the floor covering product.

36. The method according to claim 34, wherein the digital image is obtained by means of electronic submission.

37. The method according to claim 36, wherein the electronic submission of the digital image is carried out by linking to an electronic delivery address through a Web Site established by the manufacturer of the floor covering product.

38. The method according to claim 34, further comprising the step of the simulated preview image back to the prospective purchaser electronically.

39. The method according to claim 38, wherein communication of the simulated preview image back to the prospective purchaser is carried out by accessing an electronic retrieval address through a Web Site established by the manufacturer of the floor covering product.

40. The method according to claim 38, wherein communication of the simulated preview image back to the prospective purchaser is carried out as an attachment to a return message directed to the electronic address from which the image was initially submitted.

41. The method according to claim 34, wherein the digital image is obtained by digitizing a standard photograph of the area of installation.

42. The method according to claim 34, wherein shading is applied at locations across the manipulation surface to simulate shadows cast by non-floor covering elements.

43. A simulated preview image produced by the method of claim 34.

44. A system providing computer simulated viewing of pattern carpet in a floor covering installation, such as a consumer's home, through the use of digital images, digital image manipulation, and digital designs or patterns.
